(19) United States
(12) Patent Application Publication
(10) Pub. No.: US 2024/0071028 A1
(43) Pub. Date: Feb. 29, 2024

(54) INFORMATION PROCESSING DEVICE AND INFORMATION PROCESSING METHOD

(71) Applicant: OMRON Corporation, Kyoto-shi, Kyoto (JP)

(72) Inventors: Junichi SUGIO, Kyoto-shi, KYOTO (JP); Kiyoaki TANAKA, Kyoto-shi, KYOTO (JP); Takahiro TAKAYAMA, Kyoto-shi, KYOTO (JP)

(21) Appl. No.: 18/259,639

(22) PCT Filed: Sep. 14, 2021
(86) PCT No.: PCT/JP2021/033706

§ 371 Date: Jun. 28, 2023

(30) Foreign Application Priority Data
Jan. 18, 2021 (JP) 2021-005855

(51) Int. Cl. G06V 10/25; G06T 5/50; G06T 7/20; G06T 7/62; G06V 10/74

(52) U.S. Cl. CPC G06V 10/25; G06T 5/50; G06T 7/20; G06T 7/62; G06V 10/761; G06T 2207/20221; G06T 2207/20224; G06V 2201/07

(57) ABSTRACT

An information processing apparatus includes a detector that detects a movable object in a frame image of a video, a calculator that calculates a confidence of the detected movable object being a predetermined object, and a detection range determiner that determines a detection range for a first movable object detected in a first frame based on a confidence of the first movable object calculated with a range circumscribing the first movable object and on a confidence of the first movable object in the first frame calculated with a detection range for a second movable object detected in a second frame preceding the first frame and records the determined detection range into a recorder.

### FIELD

The present invention relates to an information processing device and an information processing method.

### BACKGROUND

A known method for detecting a movable object from a video extracts pixels having movement in an image as a movable object area by processing the video using a difference in a movable object (using interframe subtraction or background subtraction). Patent Literature 1 describes a technique for distinguishing and recognizing, selectively from movable objects, a movable object as a detection target and other movable objects based on physical quantity information such as a detected position.

### CITATION LIST

### Patent Literature

Patent Literature 1: Japanese Unexamined Patent Application Publication No. 2000-105835

### SUMMARY OF THE INVENTION

### Problems to be Solved by the Invention

However, a difference area extracted using the difference in the movable object can vary due to a difference in movement speed or a difference in the manner of movement. Although such a difference area may be output as a detection rectangle (detection range) that responds to a change at the latest time, the extracted movable object area may be unstable due to low accuracy in interframe subtraction or background subtraction. For example, a human who works without relocating from one place has moving parts changing over time. In this case, the rectangle for the movable object is less likely to be output with a stable size.

One or more aspects of the present invention are directed to a technique for increasing the accuracy of detecting a movable object in a video and outputting detection ranges stably.

### Means for Solving the Problem

The technique according to one or more aspects of the present invention provides the structure described below.

An information processing apparatus according to a first aspect of the present invention includes a detector that detects a movable object in a frame image of a video, a calculator that calculates a confidence of the detected movable object being a predetermined object, and a detection range determiner that determines a detection range for a first movable object detected in a first frame based on a confidence of the first movable object calculated with a range circumscribing the first movable object and on a confidence of the first movable object in the first frame calculated with a detection range for a second movable object detected in a second frame preceding the first frame and records the determined detection range into a recorder.

The information processing apparatus determines the detection range for a movable object (first movable object) detected in the current frame (first frame) based on the confidence calculated with the detection range for a movable object (second movable object) detected in the previous frame (second frame). Using the detection range with a greater confidence, the information processing apparatus increases the accuracy of detecting a movable object and outputs detection ranges stably. The predetermined object is a movable object as a detection target, such as a human.

The information processing apparatus may further include a movable-object determiner that determines, selectively from a plurality of movable objects detected in the second frame, the second movable object being a same object as the first movable object. The information processing apparatus more correctly determines, selectively from movable objects detected in the second frame, the same object as the first movable object and thus outputs the detection ranges for the same object stably.

The movable-object determiner may determine the second movable object being the same object as the first movable object based on a distance between a center of the range circumscribing the first movable object and a center of a detection range for each of the plurality of movable objects detected in the second frame. The information processing apparatus determines the second movable object being the same object as the first movable object with a simple method, thus having a less processing load.

The movable-object determiner may determine the second movable object being the same object as the first movable object based on a ratio of an overlapping area between the range circumscribing the first movable object and the detection range for each of the plurality of movable objects detected in the second frame to an area covered by the range circumscribing the first movable object and the detection range. The information processing apparatus determines the second movable object being the same object as the first movable object with a simple method, thus having a less processing load.

The movable-object determiner may determine the second movable object being the same object as the first movable object through matching between the first movable object and each of the plurality of movable objects detected in the second frame using a machine learning-based matching algorithm. The information processing apparatus accurately determines the second movable object being the same object as the first movable object.

The movable-object determiner may determine, selectively from movable objects detected in each of a plurality of frames preceding the first frame, a movable object being the same object as the first movable object in each of the plurality of frames. In response to, of confidences of the first movable object calculated with detection ranges for movable objects determined to be the same object as the first movable object in the plurality of frames, a greatest confidence being greater than the confidence of the first movable object calculated with the range circumscribing the first movable object, the detection range determiner may determine a detection range with the greatest confidence as the detection range for the first movable object. The information processing apparatus examines a plurality of preceding frames to use a detection range with a greater confidence, thus increasing the confidence calculated with the output detection range and outputting stable detection ranges.

In response to the confidence of the first movable object calculated with the range circumscribing the first movable object being greater than a first threshold, the detection range determiner may determine the range circumscribing the first movable object as the detection range for the first movable object. In response to the confidence calculated with the bounding range being greater than the first threshold, the information processing apparatus determines the detection range without comparison with the confidence calculated with the detection range in the previous frame, thus having a less processing load.

In response to the confidence of the first movable object calculated with the detection range for the second movable object being greater than the confidence of the first movable object calculated with the range circumscribing the first movable object, the detection range determiner may determine the detection range for the second movable object as the detection range for the first movable object. The information processing apparatus uses the detection range with a greater confidence to increase the accuracy of detecting a movable object.

In response to the confidence calculated with the determined detection range for the first movable object being greater than a second threshold, the detection range determiner may record the detection range for the first movable object into the recorder. A range with a confidence less than or equal to the second threshold is unrecorded into the recorder. The information processing apparatus thus outputs stable detection ranges.

In response to the confidence of the first movable object calculated with the detection range for the second movable object being greater than the confidence of the first movable object calculated with the range circumscribing the first movable object and a number of consecutive frames each having a difference greater than a third threshold between the range circumscribing the first movable object and the detection range for the second movable object being less than or equal to a predetermined number, the detection range determiner may determine the detection range for the second movable object as the detection range for the first movable object and record the determined detection range for the first movable object into the recorder. The difference may be, for example, a change in the area from the detection range for the second movable object to the range circumscribing the first movable object, or may be the ratio of such an area change to the area of the detection range for the second movable object. In response to consecutive frames each having a difference greater than the third threshold between the bounding range in the current frame and the detection range in the previous frame, the information processing apparatus records no detection range for the first movable object and can reduce outputs of erroneous detection ranges.

The information processing apparatus may further include an output unit that superimposes the detection range for the first movable object recorded in the recorder on the first frame and outputs the detection range superimposed on the first frame. With higher accuracy of detecting a movable object in a video, the information processing apparatus outputs stable detection ranges.

In response to a confidence calculated with the detection range for the first movable object recorded in the recorder being greater than a second threshold, the output unit may output the detection range for the first movable object. The information processing apparatus stably outputs detection ranges with confidences greater than the second threshold.

In response to the confidence of the first movable object calculated with the detection range for the second movable object being greater than the confidence of the first movable object calculated with the range circumscribing the first movable object and a number of consecutive frames each having a difference greater than a third threshold between the range circumscribing the first movable object and the detection range for the second movable object being less than or equal to a predetermined number, the output unit may output the detection range for the first movable object recorded in the recorder. In response to consecutive frames each having a difference greater than the third threshold between the bounding range in the current frame and the detection range in the previous frame, the information processing apparatus outputs no detection range for the first movable object and can reduce outputs of erroneous detection ranges.

In response to a number of consecutive frames each having a confidence calculated with the determined detection range for the first movable object being greater than a first threshold being greater than a predetermined number, the output unit may output the detection range for the first movable object. In response to consecutive frames each having a confidence calculated with the detection range for the first movable object being greater than the first threshold, the information processing apparatus outputs the detection range for the first movable object to constantly output detection ranges with greater confidences.

The information processing apparatus may further include a corrector that corrects the detection range for the second movable object based on a change in position and size from the detection range for the second movable object to a detection range for a movable object determined to be a same object as the first movable object in a frame preceding the second frame. The corrector 125 corrects the detection range for the movable object detected in the previous frame and uses the corrected detection range for the current frame to improve the confidence of the movable object.

The detector may detect the movable object by at least one of interframe subtraction or background subtraction. The calculator may calculate the confidence of the detected movable object being the predetermined object by using a discriminator based on at least one of a neural network, boosting, or a support vector machine.

An information processing method according to a second aspect of the present invention is implementable with a computer. The method includes detecting a first movable object in a first frame included in a video, calculating a confidence of the first movable object being a predetermined object by using a range circumscribing the first movable object and using a detection range for a second movable object detected in a second frame preceding the first frame and recorded in a recorder, and determining, based on a confidence of the first movable object calculated with the range circumscribing the first movable object and on a confidence of the first movable object in the first frame calculated with the detection range for the second movable object, a detection range for the first movable object and recording the determined detection range into the recorder.

One or more aspects of the present invention may be directed to a program for causing a computer to implement the above method or to a non-transitory storage medium storing the program. The above elements and processes may be combined with one another in any possible manner to form one or more aspects of the present invention.

### Advantageous Effects

The technique according to the above aspects of the present invention increases the accuracy of detecting a movable object in a video and outputs detection ranges stably.

### BRIEF DESCRIPTION OF THE DRAWINGS

FIG. 1 is a schematic diagram describing an example use of an information processing apparatus according to an embodiment.

FIG. 2 is a schematic diagram of the information processing apparatus showing its example hardware configuration.

FIG. 3 is a functional block diagram of the information processing apparatus.

FIG. 4 is a flowchart of an example detection rectangle output process.

FIG. 5A to FIG. 5C are diagrams each describing an object identification method.

FIG. 6 is a flowchart of an example detection rectangle output process in a second embodiment.

FIG. 7 is a flowchart of an example detection rectangle output process in a third embodiment.

FIG. 8 is a flowchart of another example detection rectangle output process in the third embodiment.

FIGS. 9A and 9B are diagrams each describing an example use of a structure according to a fourth embodiment.

FIG. 10 is a flowchart of an example detection rectangle output process in the fourth embodiment.

FIG. 11 is a flowchart of another example detection rectangle output process in the fourth embodiment.

FIG. 12 is a flowchart of an example detection rectangle output process in a fifth embodiment.

FIG. 13 is a flowchart of an example detection rectangle output process in a sixth embodiment.

FIG. 14 is a functional block diagram of an information processing apparatus according to a seventh embodiment.

FIG. 15 is a diagram describing the correction of a detection rectangle in the seventh embodiment.

FIG. 16 is a flowchart of an example detection rectangle output process in the seventh embodiment.

### DETAILED DESCRIPTION

One or more embodiments of the present invention will now be described with reference to the drawings.

### Example Use

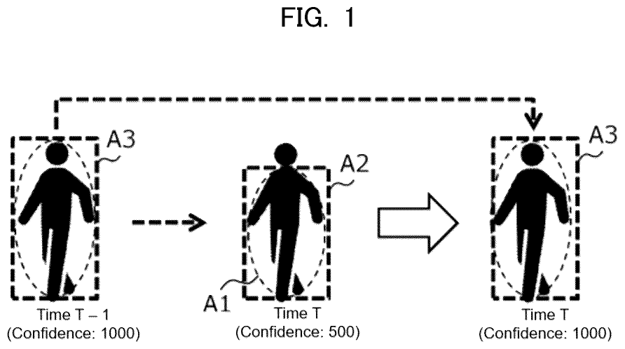

FIG. 1 is a schematic diagram describing an example use of an information processing apparatus according to an embodiment. The information processing apparatus obtains a video input from a camera and detects a movable object in each image frame of the obtained video. Examples of the camera include a fixed camera such as a surveillance camera.

The information processing apparatus detects a movable object area by, for example, background subtraction that extracts an area with a change between a frame image and a prestored background image, interframe subtraction that extracts an area with a change between frames, or both. In the example of FIG. 1, a movable object A1 is extracted at time T. The information processing apparatus generates a bounding rectangle A2 circumscribing the extracted movable object A1. In the present example and each embodiment described below, the shape of the range defining the movable object area is rectangular. In some embodiments, the shape of the range may be elliptical or polygonal, or may be defined with any other shape that surrounds the movable object area with, for example, a curved line circumscribing the movable object area.

The information processing apparatus obtains the confidence of a detected movable object by, for example, inputting the detected movable object into a machine learning-based discriminator. In the example of FIG. 1, the confidence is the likelihood of the detected object being a human. The bounding rectangle A2 includes, as the extracted movable object area, an area of a human without the head. The image of the area surrounded by the bounding rectangle A2 input into the discriminator yields a confidence of 500.

When the confidence of the movable object detected in the current frame is less than or equal to a predetermined threshold, the information processing apparatus calculates the confidence of an image cut out from the current frame using the detection rectangle for the same object detected in the previous frame. The information processing apparatus compares the calculated confidence with the confidence calculated with the bounding rectangle for the movable object detected in the current frame.

In the example of FIG. 1, with the predetermined threshold being 700, the confidence 500 for the movable object A1 calculated with the bounding rectangle A2 at time T (current frame) is less than the predetermined threshold 700. The information processing apparatus thus calculates the confidence of the image cut out from the current frame at time T by using a detection rectangle A3 for the same object as the movable object A1 at time T−1 (in the previous frame). The calculated confidence 1000 is greater than the confidence of the movable object A1 calculated with the bounding rectangle A2 at time T.

When the confidence calculated with the detection rectangle in the previous frame is greater than the confidence calculated with the bounding rectangle in the current frame, the information processing apparatus determines the detection rectangle in the previous frame as the detection rectangle for the movable object in the current frame. In the example of FIG. 1, with the confidence 1000 calculated with the detection rectangle A3 at time T−1 being greater than the confidence 500 at time T, the information processing apparatus determines the detection rectangle A3 as the detection rectangle for the movable object A1 detected in the current frame at time T. The use of the detection rectangle A3 with a greater confidence than the bounding rectangle A2 surrounding the area of the human excluding the head increases the detection accuracy at time T.

As described above, the information processing apparatus determines the detection rectangle for a movable object detected in the current frame based on the confidence calculated with the bounding rectangle for the movable object in the current frame and the confidence calculated with the detection rectangle for the same movable object detected in the previous frame. The information processing apparatus uses the rectangle having a greater confidence as a detection rectangle to increase the accuracy of detecting a movable object. For any movable object being stopped or moving slightly in a video, the information processing apparatus outputs more stable detection rectangles by using the detection rectangle in the previous image. This increases the accuracy of detecting a stationary object when a movable object is detected by interframe subtraction.

### First Embodiment

(Hardware Configuration)

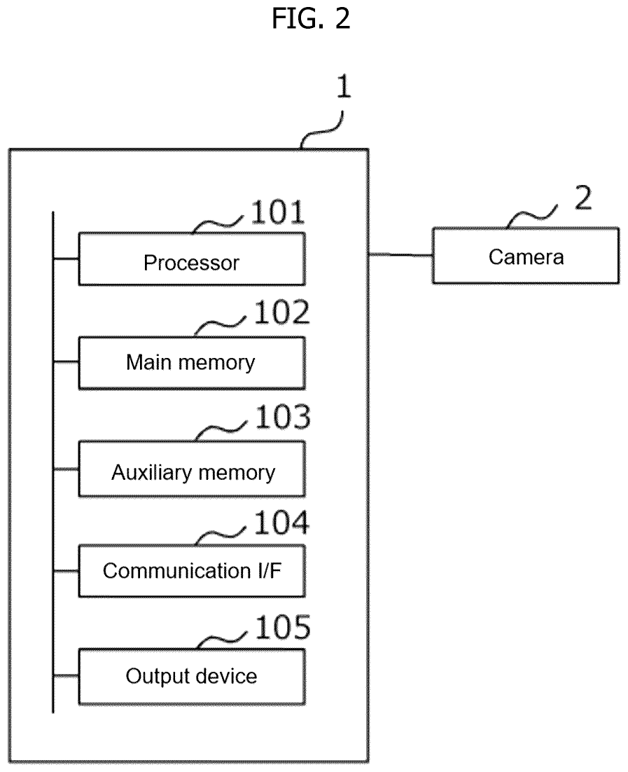

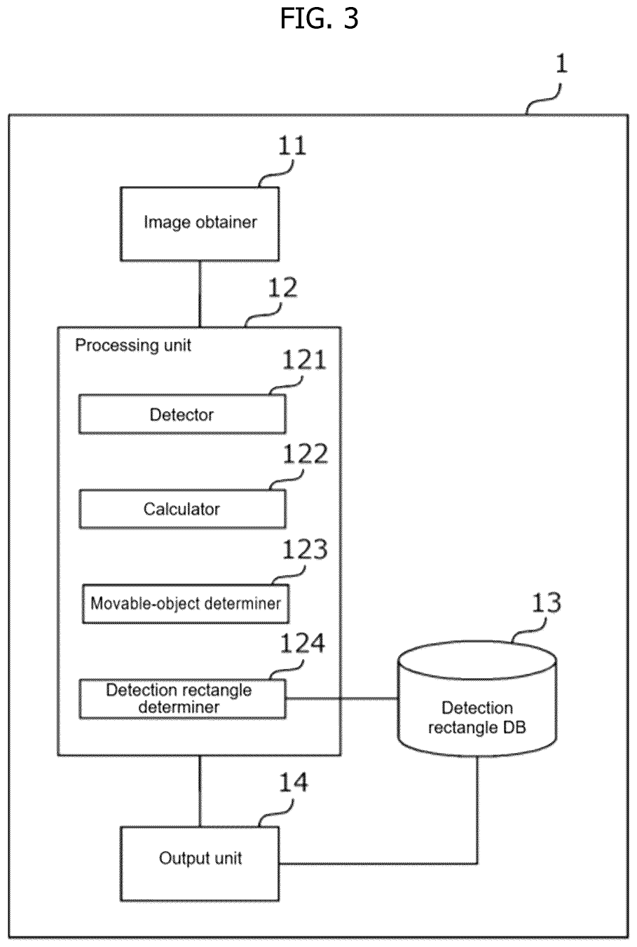

An example hardware configuration of an information processing apparatus 1 will now be described with reference to FIG. 2. FIG. 2 is a schematic diagram of the information processing apparatus 1 showing its example hardware configuration. The information processing apparatus 1 includes a processor 101, a main memory 102, an auxiliary memory 103, a communication interface (I/F) 104, and an output device 105. The processor 101 loads a program stored in the auxiliary memory 103 into the main memory 102 and executes the program to achieve the functions of the functional components described with reference to FIG. 3. The communication interface 104 allows wired or wireless communication. The output device 105 performs output and is, for example, a display.

The information processing apparatus 1 may be a general-purpose computer, such as a personal computer, a server computer, a tablet terminal, or a smartphone, or a built-in computer, such as an onboard computer. The information processing apparatus 1 may be implemented by, for example, distributed computing with multiple computer devices. At least one of the functional units may be implemented using a cloud server. At least one of the functional units of the information processing apparatus 1 may be implemented by a dedicated hardware device, such as an application-specific integrated circuit (ASIC) or a field-programmable gate array (FPGA).

The information processing apparatus 1 is connected to a camera 2 with a wire, such as a universal serial bus (USB) cable or a local area network (LAN) cable, or wirelessly, for example, through Wi-Fi, and receives image data captured with the camera 2. The camera 2 is an imaging device including an optical system including a lens and an image sensor, for example, a charge-coupled device (CCD) or a complementary metal-oxide semiconductor (CMOS).

The information processing apparatus 1 may be integral with the camera 2. At least a part of the processing performed by the information processing apparatus 1, for example, movable object detection or human determination for a captured image, may be performed by the camera 2. Further, results of human detection performed by the information processing apparatus 1 may be transmitted to an external device and presented to the user.

(Functional Configuration)

FIG. 3 is a functional block diagram of the information processing apparatus 1. The information processing apparatus 1 includes an image obtainer 11, a processing unit 12, a detection rectangle database (DB) 13, and an output unit 14. The processing unit 12 includes a detector 121, a calculator 122, a movable-object determiner 123, and a detection rectangle determiner 124.

The image obtainer 11 transmits video data obtained from the camera 2 to the processing unit 12. The detector 121 in the processing unit 12 detects a movable object in each frame of the video received from the image obtainer 11. The detector 121 may detect the movable object by, for example, background subtraction or interframe subtraction.

The calculator 122 calculates the confidence of the detected movable object being a predetermined object (e.g., human). The calculator 122 may calculate the confidence using an algorithm for a neural network such as a convolution neutral network (CNN). The calculator 122 may calculate the confidence using a machine learning-based discriminator such as boosting or a support vector machine (SVM).

The movable-object determiner 123 determines, selectively from movable objects detected in the previous frame, the same movable object as the movable object detected in the current frame. The information about the movable object detected in the previous frame and the detection rectangle for the movable object is stored in the detection rectangle database 13. The movable-object determiner 123 determines whether the movable object detected in the current frame is the same object as the movable object detected in the previous frame based on, for example, a distance between the center of the bounding rectangle for the movable object detected in the current frame and the center of the detection rectangle for the movable object detected in the previous frame.

The detection rectangle determiner 124 determines the detection rectangle for the movable object detected in the current frame based on the confidence calculated by the calculator 122 and registers the determined detection rectangle into the detection rectangle database 13. When, for example, the confidence calculated with the bounding rectangle for the movable object detected in the current frame is greater than the predetermined threshold, the detection rectangle determiner 124 determines the bounding rectangle as the detection rectangle for the movable object in the current frame and registers the determined detection rectangle into the detection rectangle database 13.

When the confidence calculated with the bounding rectangle in the current frame is less than or equal to the predetermined threshold, the detection rectangle determiner 124 uses the detection rectangle for the same object detected in the previous frame for the current frame to calculate the confidence. The detection rectangle determiner 124 determines, of the bounding rectangle in the current frame and the detection rectangle for the same object in the previous frame, the rectangle with a greater confidence as the detection rectangle for the movable object detected in the current frame, and registers the determined detection rectangle into the detection rectangle database 13.

The detection rectangle database 13 stores the movable object detected in each frame of the video together with its corresponding detection rectangle determined by the detection rectangle determiner 124. The detection rectangle database 13 stores, as information about each detection rectangle, for example, the position and the size of each detection rectangle within the frame. The detection rectangle database 13 may store, as the information about each detection rectangle, the confidence of the corresponding movable object calculated by the calculator 122. The detection rectangle database 13 is an example of a recorder.

The output unit 14 superimposes the detection rectangle for the detected movable object on each frame image based on the information about each movable object and the corresponding detection rectangle stored in the detection rectangle database 13, and outputs the superimposed image to the output device 105 such as a display.

(Detection Rectangle Output Process)

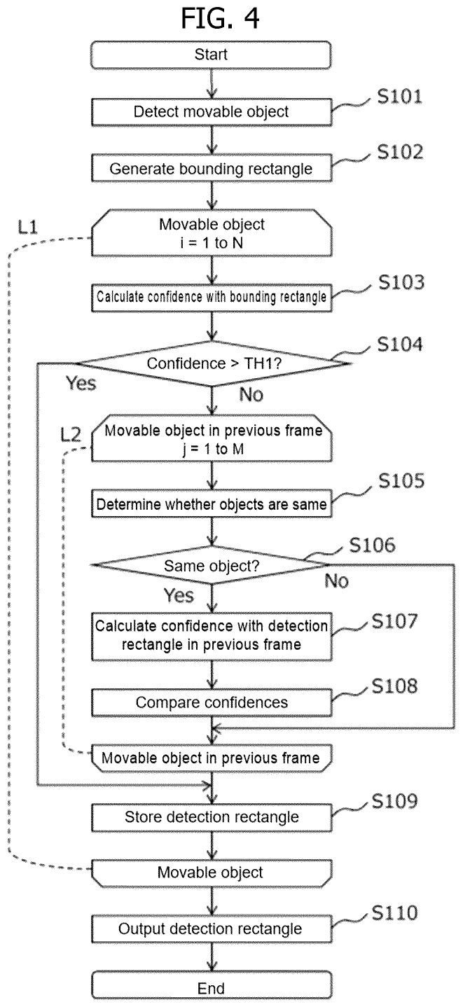

An overall detection rectangle output process will now be described with reference to FIG. 4. FIG. 4 is a flowchart of an example detection rectangle output process. The detection rectangle output process starts in response to, for example, a frame of a video calculated with the image obtainer 11 being transmitted to the processing unit. The detection rectangle output process shown in FIG. 4 is performed for each frame of the video.

In S101, the detector 121 detects a movable object from an image of a frame to be processed (hereafter referred to as the current frame) received from the image obtainer 11. The detector 121 may detect the movable object using background subtraction that extracts an area with a change between a frame image and a prestored background image or interframe subtraction that extracts an area with a change between frames.

In S102, the detector 121 generates a bounding rectangle circumscribing each movable object detected in the current frame. Each movable object i (i=1 to N) detected in the current frame repeatedly undergoes the processing in S103 to S109.

In S103, the calculator 122 calculates the confidence of an image cut out from the current frame with the bounding rectangle generated in S102. The confidence represents the likelihood of the movable object i in the cut-out image being a predetermined object, for example, a human. The calculator 122 may calculate the confidence using an algorithm for a neural network such as a CNN or using a machine learning-based discriminator such as boosting or an SVM.

In S104, the detection rectangle determiner 124 determines whether the confidence calculated with the bounding rectangle calculated in S103 is greater than a predetermined threshold TH1 (first threshold). When the confidence calculated with the bounding rectangle is greater than the predetermined threshold TH1 (Yes in S104), the processing advances to S109. When the confidence calculated with the bounding rectangle is less than or equal to the predetermined threshold TH1 (No in S104), the processing advances to loop processing L2 including the processing in S105 to S108.

In the loop processing L2, the calculator 122 calculates the confidence of the movable object i in the current frame using, selectively from detection rectangles for movable objects j (j=1 to M) detected in the previous frame, the detection rectangle for a movable object jₘ that is the same object as the movable object i. The detection rectangle determiner 124 determines a detection rectangle for the movable object i in the current frame based on the calculated confidence and the confidence calculated with the bounding rectangle for the movable object i. Processing in each step will now be described in detail.

In S105, the movable-object determiner 123 determines whether the movable object j detected in the previous frame is the same object as the movable object i in the current frame. Upon determination that the movable object j detected in the previous frame is the same object as the movable object i in the current frame (Yes in S106), the processing advances to S107. Upon determination that the movable object j is different from the movable object i in the current frame (No in S106), the processing advances to the loop processing L2 to be performed on the detection rectangle for the next movable object j+1.

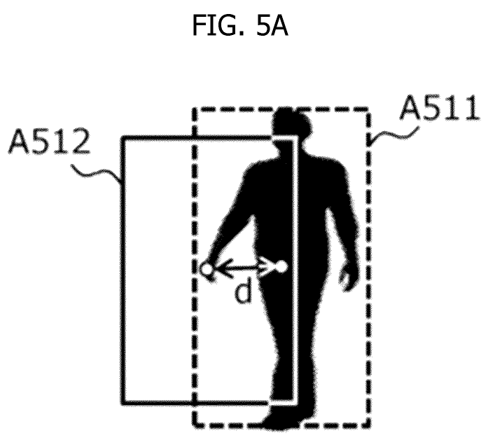

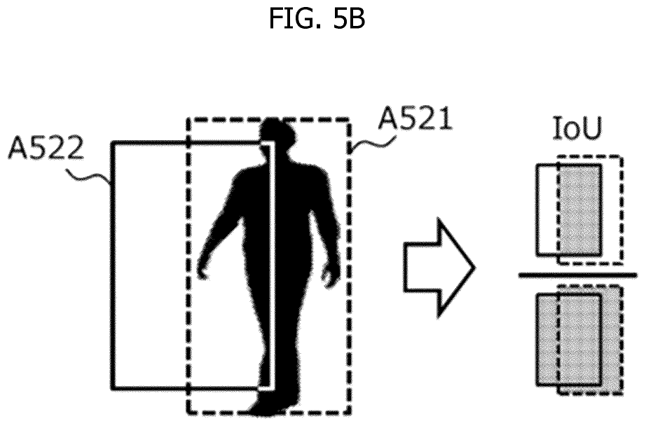

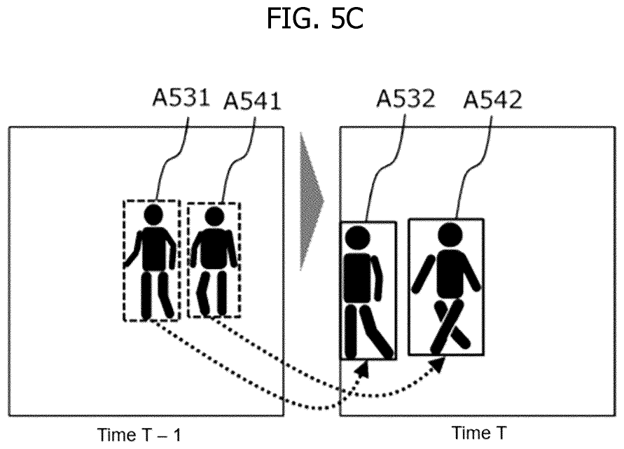

Referring now to FIGS. 5A to 5C, three examples of an object identification method for determining, in S105 and S106, whether the movable object j in the previous frame is the same object as the movable object i in the current frame will now be described. The three example methods below may be combined within an allowable range to determine whether the objects are the same.

FIG. 5A shows a first example of the object identification method. The movable-object determiner 123 determines whether the movable object j in the previous frame is the same object as the movable object i in the current frame based on a distance d between the center of a bounding rectangle A512 circumscribing the movable object i in the current frame and the center of a detection rectangle A511 for the movable object j in the previous frame.

When, for example, the distance d between the centers is less than a predetermined threshold, the movable-object determiner 123 determines that the movable object j in the previous frame is the same object as the movable object i in the current frame. The predetermined threshold for the distance d between the centers may be, for example, half the width of the bounding rectangle A512 circumscribing the movable object i in the current frame.

FIG. 5B shows a second example of the object identification method. The movable-object determiner 123 determines whether the movable object j in the previous frame is the same object as the movable object i in the current frame based on Intersection over Union (IoU) between a bounding rectangle A522 circumscribing the movable object i in the current frame and a detection rectangle A521 for the movable object j in the previous frame. IoU indicates the ratio of the overlapping area between the bounding rectangle A522 circumscribing the movable object i in the current frame and the detection rectangle A521 for the movable object j in the previous frame to the area (area of union) covered by the bounding rectangle A522 and the detection rectangle A521.

When, for example, the IoU is greater than a predetermined threshold, the movable-object determiner 123 determines that the movable object j detected in the previous frame is the same object as the movable object i in the current frame. The predetermined threshold for the IoU may be, for example, 80%.

FIG. 5C shows a third example of the object identification method. The movable-object determiner 123 determines whether the movable object j detected in the previous frame is the same object as the movable object i in the current frame through matching between the movable object i in the current frame and the movable object j in the previous frame using a machine learning-based matching algorithm (Re-Id).

In the example of FIG. 5C, a movable object A531, of the movable objects A531 and A541 detected at time T−1, is determined as the same object as a movable object A532 detected at time T. The movable object A541 is determined as the same object as a movable object A542 detected at time T. The movable-object determiner 123 can accurately determine the same objects using a machine learning-based matching algorithm.

The movable-object determiner 123 obtains, for example, similarity between the movable object detected in the current frame and each of multiple movable objects detected in the previous frame. The movable-object determiner 123 may determine, selectively from movable objects each having a similarity level greater than or equal to a threshold (e.g., 0.5 for the maximum value being 1), the movable object with the greatest similarity level as the same object as the movable object detected in the current frame.

In S107 in FIG. 4, the calculator 122 calculates the confidence of the movable object i cut out from the current frame using the detection rectangle for the movable object jₘ determined as the same object as the movable object i in the current frame.

In S108, the detection rectangle determiner 124 compares the confidence calculated in S107 with the detection rectangle for the movable object jₘ in the previous frame with the confidence calculated in S103 with the bounding rectangle. When the confidence with the bounding rectangle for the movable object i in the current frame is greater than the confidence with the detection rectangle for the movable object j m in the previous frame, the detection rectangle determiner 124 determines the bounding rectangle as the detection rectangle for the movable object i in the current frame. When the confidence with the detection rectangle for the movable object jₘ in the previous frame is greater than the confidence with the bounding rectangle, the detection rectangle determiner 124 determines the detection rectangle for the movable object jₘ in the previous frame as the detection rectangle for the movable object i in the current frame.

When multiple movable objects jₘ, selectively from the movable objects j in the previous frame, are determined as the same object as the movable object i in the current frame, the detection rectangle having the greatest confidence calculated in S107 may be compared with the confidence calculated in S103 with the bounding rectangle.

In S109, the detection rectangle determiner 124 records, into the detection rectangle database 13, information about the detection rectangle determined in S108 as the detection rectangle for the movable object i in the current frame. The information about the detection rectangle includes the image information about the movable object i, the position and the size of the determined detection rectangle, and the confidence value for the movable object i calculated with the determined detection rectangle.

The detection rectangle for the movable object i in the current frame recorded into the detection rectangle database 13 in S109 is used to calculate the confidence of a movable object to be detected in the next frame. After loop processing L1 including the processing in S103 to S109 ends for each movable object detected in the current frame, the processing advances to S110.

In S110, the output unit 14 superimposes the detection rectangle determined in S108 on the image of the current frame. This ends the detection rectangle output process in the current frame.

(Effects)

In the first embodiment described above, the information processing apparatus 1 compares the confidence of a movable object in the current frame calculated with the bounding rectangle circumscribing the movable object with the confidence of the movable object in the current frame calculated with the detection rectangle for the same movable object detected in the previous frame. The information processing apparatus 1 determines, of the rectangles subjected to confidence comparison, a rectangle having a greater confidence as the detection rectangle for the movable object in the current frame. With the detection rectangle having a greater confidence, the information processing apparatus 1 detects the movable object with higher accuracy and outputs detection rectangles stably.

When the confidence of the movable object calculated with the bounding rectangle in the current frame is greater than the predetermined threshold (first threshold), the information processing apparatus 1 records the bounding rectangle as the detection rectangle for the movable object in the current frame. When the confidence is greater than the predetermined threshold, the information processing apparatus 1 performs no comparison with the confidence calculated with the detection rectangle in the previous frame and thus has a less processing load.

The information processing apparatus 1 determines whether the movable object detected in the current frame is the same object as the movable object detected in the previous frame in S105 and S106 in the detection rectangle output process shown in FIG. 4. The object identification method using the distance between the centers described with reference to FIG. 5A and the object identification method using IoU described with reference to FIG. 5B can determine whether the objects are the same with a less load than the object identification method using machine learning described with reference to FIG. 5C. The object identification method using machine learning described with reference to FIG. 5C can determine whether the objects are the same more accurately than the object identification method using the distance between the centers and the object identification method using IoU.

### Second Embodiment

In the first embodiment, when the confidence calculated with the bounding rectangle for the movable object detected in the current frame is greater than the predetermined threshold, the information processing apparatus 1 determines the bounding rectangle in the current frame as the detection rectangle for the detected movable object without comparison with the confidence calculated with the detection rectangle in the previous frame. The information processing apparatus 1 according to a second embodiment performs, independently of the confidence calculated with the bounding rectangle for the movable object detected in the current frame, comparison with the confidence calculated with the detection rectangle for the same movable object detected in the previous frame and determines the rectangle with a greater confidence as the detection rectangle for the movable object detected in the current frame.

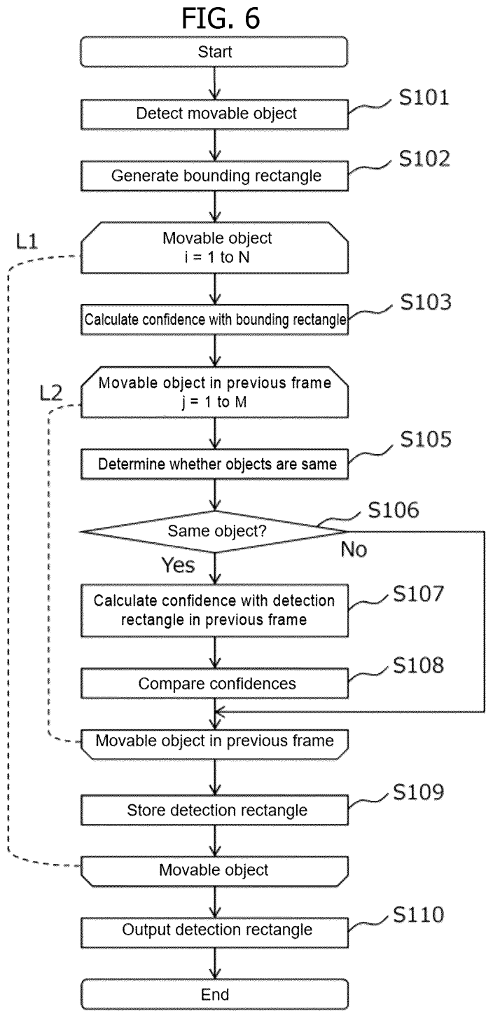

The hardware configuration and the functional components of the information processing apparatus 1 according to the second embodiment are the same as in the first embodiment, and will not be described. FIG. 6 is a flowchart of an example detection rectangle output process in the second embodiment. The detection rectangle output process in the second embodiment differs from the detection rectangle output process in the first embodiment shown in FIG. 4 in eliminating the determination process in S104. The same reference numerals denote the same processing as in the detection rectangle output process in the first embodiment shown in FIG. 4, and such processing will not be described. The detection rectangle output process in the second embodiment shown in FIG. 6 may also be performed by setting the threshold TH1 in S104 to the maximum confidence value in the detection rectangle output process shown in FIG. 4.

In the second embodiment, the movable-object determiner 123 compares, independently of whether the confidence of the movable object i calculated with the bounding rectangle is greater than the threshold TH1, the confidence calculated with the bounding rectangle with the confidence of the movable object i calculated with the detection rectangle for the movable object j detected in the previous frame. Independently of the confidence of the movable object i calculated with the bounding rectangle, a rectangle, of rectangles including the detection rectangle in the previous frame, with a greater confidence is used. This increases the accuracy of a detection rectangle to be output.

### Third Embodiment

In a third embodiment, when the confidence calculated with the detection rectangle determined by the detection rectangle determiner 124 is less than or equal to a predetermined threshold, no detection rectangle is output. When the confidence is greater than the predetermined threshold, the detection rectangle is output. The information processing apparatus 1 outputs no detection rectangle when the confidence is less than or equal to the predetermined threshold, and thus constantly outputs detection rectangles with a stable confidence.

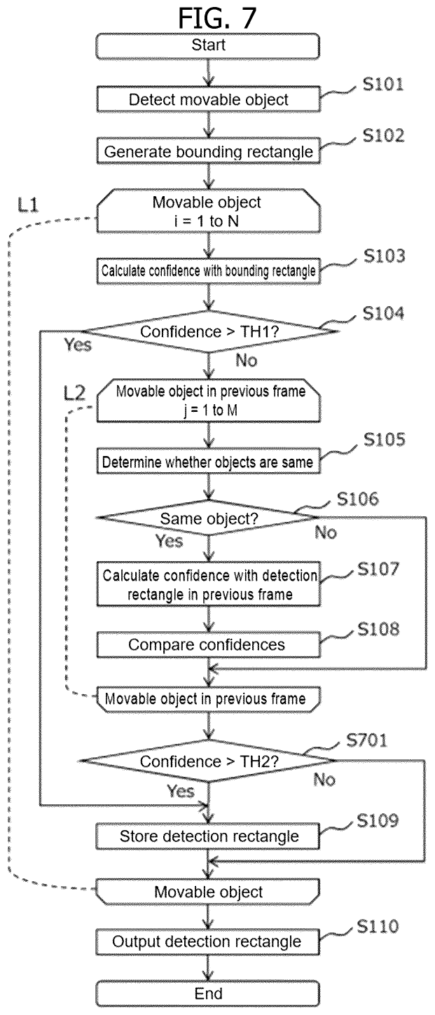

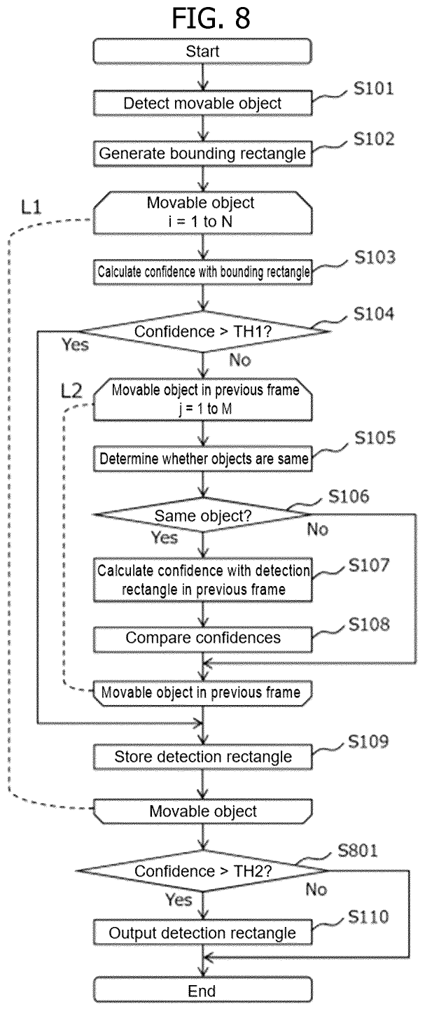

The hardware configuration and the functional components of the information processing apparatus 1 according to the third embodiment are the same as in the first embodiment, and will not be described. FIGS. 7 and 8 are flowcharts each showing an example detection rectangle output process in the third embodiment. Each detection rectangle output process in the third embodiment includes, in addition to the detection rectangle output process in the first embodiment shown in FIG. 4, determining whether the confidence calculated with the detection rectangle is greater than the predetermined threshold (S701 and S801). The same reference numerals denote the same processing as in the detection rectangle output process in the first embodiment shown in FIG. 4, and such processing will not be described.

The detection rectangle output process in FIG. 7 and the detection rectangle output process in FIG. 8 differ from each other in the timing at which determination is performed as to whether the confidence calculated with the detection rectangle is greater than a predetermined threshold TH2 (second threshold). In FIG. 7, the determination as to whether the confidence calculated with the detection rectangle is greater than the predetermined threshold TH2 is performed before the information about the detection rectangle is stored into the detection rectangle database 13 in S109. In other words, when the confidence calculated with the detection rectangle is less than or equal to the predetermined threshold TH2, no detection rectangle is stored into the detection rectangle database 13 or output. In FIG. 8, the determination as to whether the confidence calculated with the detection rectangle is greater than the predetermined threshold TH2 is performed before the detection rectangle is output in S110. In other words, when the confidence calculated with the detection rectangle is less than or equal to the predetermined threshold TH2, the detection rectangle is stored into the detection rectangle database 13, but is not output.

In the example of FIG. 7, in response to the detection rectangle for the movable object i being determined in the loop processing L2, the processing advances to S701. In S701, the detection rectangle determiner 124 determines whether the confidence calculated with the determined detection rectangle is greater than the predetermined threshold TH2. The predetermined threshold TH2 may be set to, for example, a value less than or equal to the threshold TH1. When the confidence calculated with the determined detection rectangle is greater than the predetermined threshold TH2 (Yes in S701), the processing advances to S109. When the confidence calculated with the determined detection rectangle is less than or equal to the predetermined threshold TH2 (No in S701), the processing advances to the loop processing L1 for the next movable object i+1.

In S109, the information about the determined detection rectangle with the confidence greater than the predetermined threshold TH2 is stored into the detection rectangle database 13. In S110, the output unit 14 outputs the detection rectangle stored in the detection rectangle database 13 for the movable object detected in the current frame. In other words, the output unit 14 outputs the bounding rectangle for the movable object i with the confidence greater than the predetermined threshold TH1 in S104 and the detection rectangle determined to have the confidence greater than the predetermined threshold TH2 in S701. The information processing apparatus 1 outputs no rectangle with a confidence less than or equal to the predetermined threshold, and thus constantly outputs detection rectangles with a stable confidence.

In the example of FIG. 8, in response to the detection rectangle for each movable object detected in the current frame being recorded into the detection rectangle database 13 in the loop processing L1, the processing advances to S801. In S801, the output unit 14 determines whether the confidence calculated with the detection rectangle for each movable object recorded in the detection rectangle database 13 is greater than the predetermined threshold TH2.

For any movable object with a confidence greater than the predetermined threshold TH2 (Yes in S801), the processing advances to S110. For any movable object with a confidence less than or equal to the predetermined threshold TH2 (No in S801), no detection rectangle is output. The detection rectangle output process shown in FIG. 8 for the current frame ends.

In S110, the output unit 14 outputs, selectively from the detection rectangles stored in the detection rectangle database 13, the detection rectangle determined in S801 to have a confidence greater than the predetermined threshold TH2. The information processing apparatus 1 outputs no rectangle with a confidence less than or equal to the predetermined threshold, and thus constantly outputs detection rectangles with a stable confidence.

### Fourth Embodiment

The structure according to a fourth embodiment is designed to avoid the situation in which a detection rectangle for a stationary object with a greater confidence than the bounding rectangle for a movable object in the current frame is selected and stored as the detection rectangle for the movable object. The hardware configuration and the functional components of the information processing apparatus 1 according to the fourth embodiment are the same as in the first embodiment, and will not be described.

The information processing apparatus 1 identifies the number of consecutive frames each having a difference greater than a predetermined threshold between the bounding rectangle for the movable object detected in the current frame and the detection rectangle for the movable object determined to be the same object in the previous frame. When the number of consecutive frames is greater than a predetermined number, the information processing apparatus 1 outputs no detection rectangle. The difference may be, for example, a change in the area from the detection rectangle in the previous frame to the bounding rectangle in the current frame, or may be the ratio of such an area change to the area of the detection rectangle in the previous frame. In other words, when the number of frames each having a difference greater than the predetermined threshold between the bounding rectangle for the movable object in the current frame and the detection rectangle in the previous frame is less than or equal to the predetermined number, the information processing apparatus 1 records the detection rectangle determined by the detection rectangle determiner 124 as the detection rectangle for the movable object. The information processing apparatus 1 can thus avoid, in the subsequent frames, using the detection rectangle for the stationary object erroneously selected as the detection rectangle for the movable object.

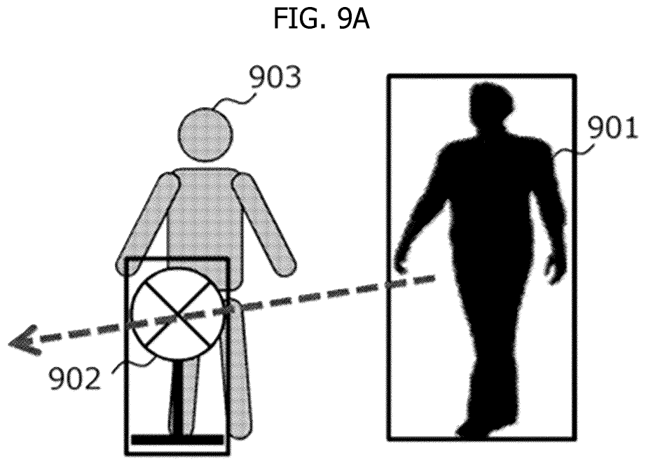

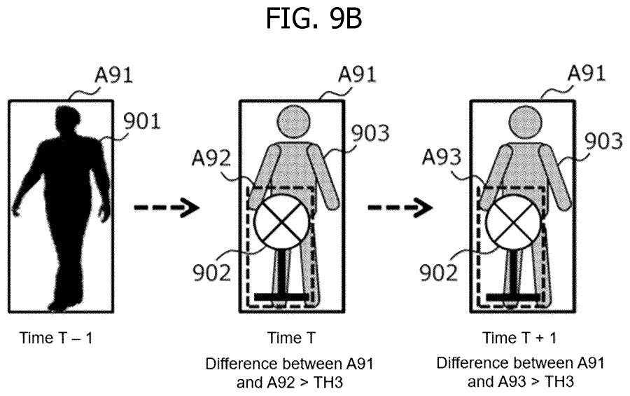

An example use of the structure according to the fourth embodiment will now be described with reference to FIGS. 9A and 9B. In the example of FIG. 9A, a human is detected as a detection target in a frame image. An object 902 is detectable as a movable object, and may be, for example, a fan. An object 903 overlaps the object 902 in the image. The object 903 may be erroneously detected as a human. The object 903 is any object, such as a robot, a poster showing a photographed human, a coat hook, or a pattern of a wall, that overlaps the object 902 and is possibly determined as a human. FIG. 9A shows an example use of the structure according to the present embodiment. As viewed from the camera 2, a human 901 passes by to overlap the object 902.

FIG. 9B shows an example result of detecting a movable object in the situation of FIG. 9A from time T−1 to time T+1. Time T is immediately after the human 901 passes by the position overlapping the object 902 as viewed from the camera 2.

In the frame image at time T−1, the human 901 is detected near the object 902, and a detection rectangle A91 is recorded into the detection rectangle database 13 as the detection rectangle for the human 901. When the object 902 is detected at time T, the movable-object determiner 123 is expected to determine that the human 901 at time T−1 is the same object as the object 902 based on the distance between the center of a bounding rectangle A92 for the object 902 and the center of the detection rectangle A91 for the human 901. In this case, the calculator 122 calculates the confidence of the object 902 using the detection rectangle A91 for the human 901. Due to the presence of the object 903, the confidence of the object 902 (confidence as the likelihood of the object being a human) calculated with the detection rectangle A91 is greater than the confidence of the object 902 calculated with the bounding rectangle A92. This causes the detection rectangle determiner 124 to determine the detection rectangle A91 at time T−1 as the detection rectangle for the object 902.

When the object 903 is a stationary object, the detection rectangle determiner 124 determines the detection rectangle A91 at time T−1 and the time T as the detection rectangle for the object 902 also at time T+1, in the same manner as for time T. At times subsequent to the time T+1 as well, the detection rectangle A91 is erroneously recorded into the detection rectangle database 13 as the detection rectangle for the object 902.

To avoid this situation, with the predetermined number of consecutive frames each having a difference greater than a predetermined threshold TH3 between the bounding rectangle in the current frame and the detection rectangle in the previous frame, the information processing apparatus 1 does not record the detection rectangle A91 into the detection rectangle database 13.

For example, the difference in the example of FIG. 9B may be the ratio of the change in the area from the detection rectangle A91 to the bounding rectangle A92 to the area of the detection rectangle A91 in the previous frame. In this case, with more than five consecutive frames each having a difference greater than the predetermined threshold TH3 of 50%, the information processing apparatus 1 does not record the detection rectangle A91 into the detection rectangle database 13. In other words, with less than five consecutive frames each having a difference greater than the predetermined threshold TH3 of 50%, the information processing apparatus 1 records the detection rectangle A91. The information processing apparatus 1 determines whether each detection rectangle is to be recorded based on the difference between the detection rectangle in the previous frame and the bounding rectangle in the current frame to avoid more than a predetermined number of erroneous detection rectangles being output constantly.

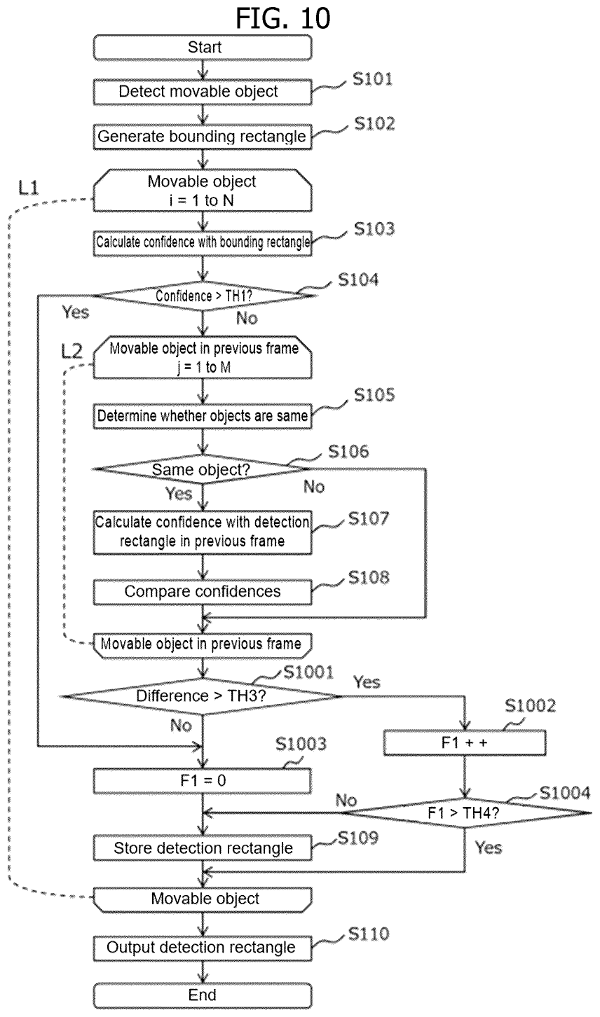

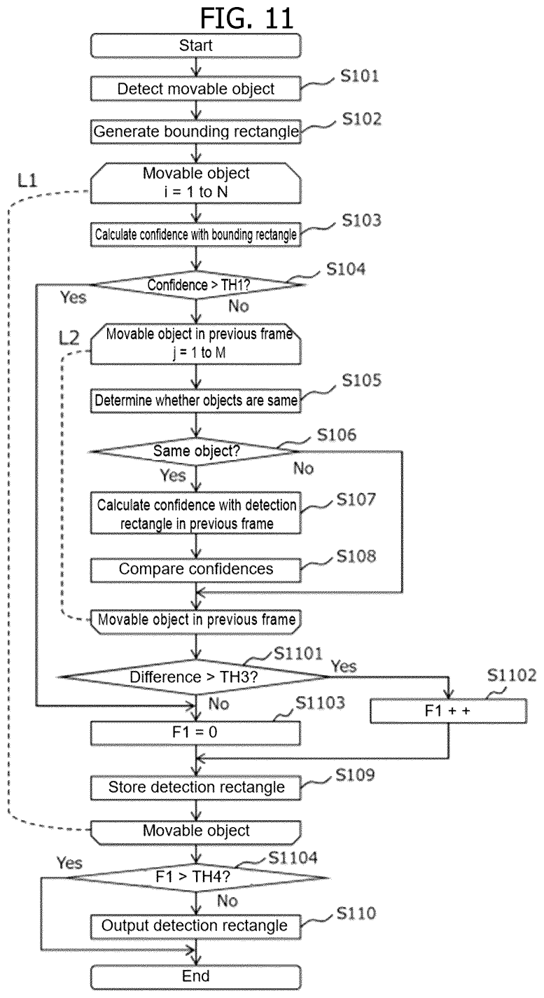

FIGS. 10 and 11 are flowcharts each showing an example detection rectangle output process in the fourth embodiment. Each detection rectangle output process in the fourth embodiment includes, in addition to the detection rectangle output process in the first embodiment shown FIG. 4, determination (S1001 to S1004 and S1101 to S1104) about the number of consecutive frames each having a difference in rectangles greater than a predetermined threshold. The same reference numerals denote the same processing as in the detection rectangle output process in the first embodiment shown in FIG. 4, and such processing will not be described.

The detection rectangle output process in FIG. 10 and the detection rectangle output process in FIG. 11 differ from each other in the timing at which determination is performed as to whether the number of consecutive frames each having a difference in rectangles greater than the predetermined threshold TH3 (third threshold) is greater than a predetermined number TH4. In FIG. 10, the determination as to whether the number of consecutive frames is greater than the predetermined number TH4 is performed before the information about the detection rectangle is stored into the detection rectangle database 13 in S109. In other words, when the number of consecutive frames is less than or equal to the predetermined number, no detection rectangle is stored into the detection rectangle database 13 or output. In FIG. 11, the determination as to whether the number of consecutive frames is greater than the predetermined number TH4 is performed before the detection rectangle is output in S110. In other words, when the number of consecutive frames is less than or equal to the predetermined number TH4, the detection rectangle is stored into the detection rectangle database 13, but is not output.

In the example of FIG. 10, in response to the detection rectangle for the movable object i being determined in the loop processing L2, the processing advances to S1001. In S1001, the difference between the detection rectangle in the previous frame and the bounding rectangle in the current frame is calculated. The difference between the rectangles may be calculated as, for example, the change in the area between the bounding rectangle for the movable object i and the detection rectangle for the movable object i determined in S108. The difference between the rectangles is recorded into the detection rectangle database 13 together with the information about the detection rectangle.

The detection rectangle determiner 124 determines whether the difference between the rectangles for the movable object i is greater than the predetermined threshold TH3. When the difference between the rectangles for the movable object i is greater than the predetermined threshold TH3 (Yes in S1001), the processing advances to S1002. When the difference between the rectangles for the movable object i is less than or equal to the predetermined threshold TH3 (No in S1001), the processing advances to S1003. In S1003, the detection rectangle determiner 124 initializes the number F1 of consecutive frames each having a change in the difference between the rectangles greater than the predetermined threshold TH3. The processing then advances to S109, in which the detection rectangle determined for the movable object i in S108 is recorded into the detection rectangle database 13.

In S1002, the detection rectangle determiner 124 increments, by 1, the number F1 of consecutive frames each having a difference greater than the predetermined threshold TH3 between the rectangles for the movable object i. The number F1 of consecutive frames each having a difference greater than the predetermined threshold TH3 between the rectangles for the movable object i is recorded into the detection rectangle database 13 for reference in the processing of each frame.

In S1004, the detection rectangle determiner 124 determines whether the number F1 of consecutive frames is greater than the predetermined number TH4. When the number F1 of consecutive frames is greater than the predetermined number TH4 (Yes in S1004), the detection rectangle for the movable object i is not recorded into the detection rectangle database 13, and the processing advances to the loop processing L1. When the number F1 of consecutive frames is less than or equal to the predetermined number TH4 (No in S1004), the processing advances to S109, in which the detection rectangle for the movable object i is recorded into the detection rectangle database 13.

The information processing apparatus 1 outputs no detection rectangle when the number of consecutive frames each having a difference in the rectangles being greater than the predetermined threshold is greater than the predetermined number, thus reducing outputs of erroneous detection rectangles.

In the example of FIG. 11, the processing in S1101 to S1103 is similar to the processing in S1001 to S1003 in FIG. 10. After incrementing the number F1 of consecutive frames by 1 in S1102 or initializing the number F1 to 0 in S1103, the detection rectangle determiner 124 records the number F1 of consecutive frames into the detection rectangle database 13. In S109, for any number F1 of consecutive frames, the detection rectangle determiner 124 records the information about the movable object i and the detection rectangle for the movable object i into the detection rectangle database 13.

In response to the detection rectangle for each movable object detected in the current frame being recorded into the detection rectangle database 13, the processing advances to S1104. In S1104, the output unit 14 determines whether the number F1 of consecutive frames is greater than the predetermined number TH4.

For any movable object i with the number F1 of consecutive frames greater than the predetermined number TH4 (Yes in S1104), no detection rectangle is output, and the detection rectangle output process shown in FIG. 11 for the current frame ends. In this case, the output unit 14 initializes the number F1 of consecutive frames for the movable object i recorded in the detection rectangle database 13 to 0. For any movable object i with the number F1 of consecutive frames less than or equal to the predetermined number TH4 (No in S1104), the processing advances to S110.

In S110, the output unit 14 outputs, selectively from the detection rectangles stored in the detection rectangle database 13, the detection rectangle determined in S1104 to have the number F1 of consecutive frames being less than or equal to the predetermined number TH4. The information processing apparatus 1 outputs no detection rectangle when the number of consecutive frames each having a difference in the rectangles being greater than the predetermined threshold is greater than the predetermined number, thus reducing outputs of erroneous detection rectangles.

### Fifth Embodiment

The structure according to a fifth embodiment outputs a detection rectangle when a predetermined number of consecutive frames each having a confidence greater than a predetermined threshold appears. When the confidence is less than or equal to the predetermined threshold, the information processing apparatus 1 outputs no detection rectangle and thus constantly outputs detection rectangles with a stable confidence.

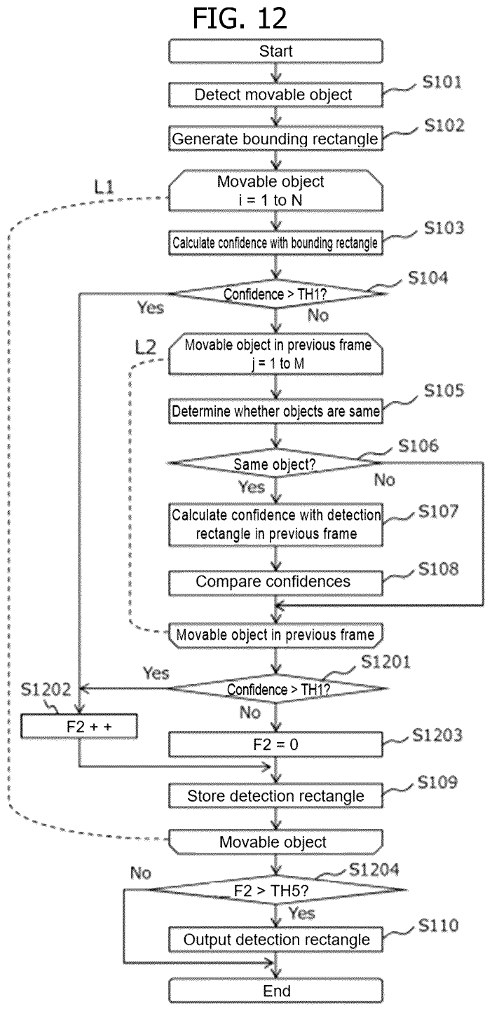

The hardware configuration and the functional components of an information processing apparatus 1 according to the fifth embodiment are the same as in the first embodiment, and will not be described. FIG. 12 is a flowchart of an example detection rectangle output process in the fifth embodiment. The detection rectangle output process in the fifth embodiment includes, in addition to the detection rectangle output process in the first embodiment shown in FIG. 4, determination (S1201 to S1204) about the number of consecutive frames each having a confidence greater than the predetermined threshold. The same reference numerals denote the same processing as in the detection rectangle output process in the first embodiment shown in FIG. 4, and such processing will not be described.

In the example of FIG. 12, when the confidence calculated with the bounding rectangle is greater than the predetermined threshold TH1 in S104 (Yes in S104), the processing advances to S1202.

In S1202, the detection rectangle determiner 124 increments, by 1, the number F2 of consecutive frames each having a confidence greater than the predetermined threshold. The number F2 of consecutive frames each having a confidence greater than the predetermined threshold is recorded into the detection rectangle database 13 for reference in the processing of each frame.

In response to the detection rectangle for the movable object i being determined in the loop processing L2 in FIG. 12, the processing advances to S1201. In S1201, the detection rectangle determiner 124 determines whether the confidence of the movable object i calculated with the detection rectangle determined in the loop processing L2 is greater than the predetermined threshold TH1. When the confidence calculated with the determined detection rectangle is greater than the predetermined threshold TH1 (Yes in S1201), the processing advances to S1202. When the confidence calculated with the determined detection rectangle is less than or equal to the predetermined threshold TH1 (No in S1201), the processing advances to S109.

In S1202, the detection rectangle determiner 124 increments, by 1, the number F2 of consecutive frames each having a confidence greater than the predetermined threshold. In S109, for any number F2 of consecutive frames, the detection rectangle determiner 124 records the information about the movable object i and the detection rectangle for the movable object i into the detection rectangle database 13.

In S1203, with the confidence determined in S1201 being less than or equal to the predetermined threshold TH1 without any consecutive frames each having a confidence greater than the predetermined threshold, the detection rectangle determiner 124 initializes the number F2 of consecutive frames for the movable object i to 0.

In response to the detection rectangle for each movable object detected in the current frame being recorded into the detection rectangle database 13, the processing advances to S1204. In S1204, the output unit 14 determines whether the number F2 of consecutive frames is greater than a predetermined number TH5.

For any movable object i with the number F2 of consecutive frames greater than the predetermined number TH5 (Yes in S1204), the processing advances to S110. For any movable object i with the number F2 of consecutive frames less than or equal to the predetermined number TH5 (No in S1204), no detection rectangle is output, and the detection rectangle output process shown in FIG. 12 for the current frame ends.

In S110, the output unit 14 outputs, selectively from the detection rectangles stored in the detection rectangle database 13, the detection rectangle determined in S1204 to have the number F2 of consecutive frames greater than the predetermined number TH5. With the number F2 of consecutive frames less than or equal to the predetermined number TH5, the information processing apparatus 1 outputs no detection rectangle and thus constantly outputs detection rectangles with a high confidence.

### Sixth Embodiment

In the above embodiments, the confidence calculated with the bounding rectangle for the movable object in the current frame is compared with the confidence calculated with the detection rectangle for the same movable object in the previous frame. In a sixth embodiment, the confidence calculated with the bounding rectangle for the movable object in the current frame is compared with the confidence calculated with each of the detection rectangles for the same movable object detected in multiple preceding frames. In the sixth embodiment, the information processing apparatus 1 outputs, as the detection rectangle for the movable object in the current frame, selectively from the bounding rectangle in the current frame and the detection rectangles in the multiple preceding frames, the rectangle with the greatest confidence.

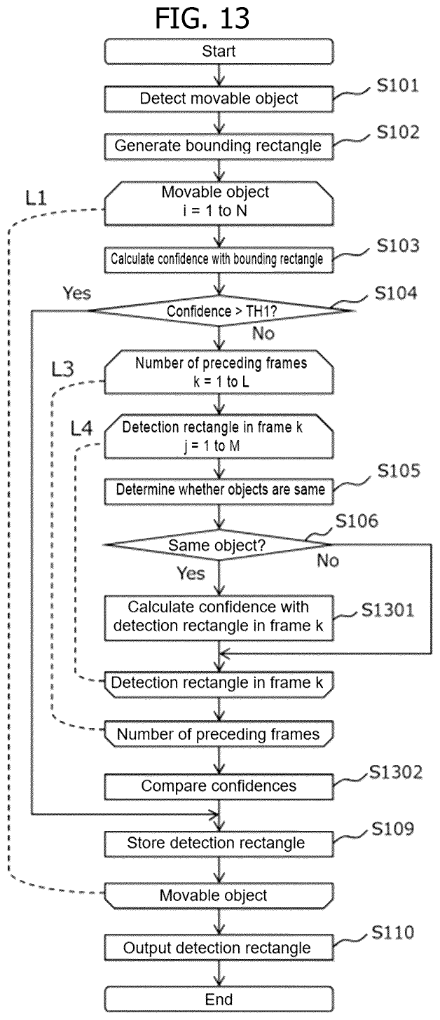

The hardware configuration and the functional components of the information processing apparatus 1 according to the sixth embodiment are the same as in the first embodiment, and will not be described. FIG. 13 is a flowchart of an example detection rectangle output process in the sixth embodiment. The detection rectangle output process in the sixth embodiment includes, in addition to the detection rectangle output process in the first embodiment shown in FIG. 4, loop processing L3 of examining preceding frames. The same reference numerals denote the same processing as in the detection rectangle output process in the first embodiment shown in FIG. 4, and such processing will not be described.

In the example of FIG. 13, loop processing L4 in S105, S106, and S1301 is repeated for each of k (k=1 to L) preceding frames. The number L of preceding frames to be examined may be, for example, five, and may be determined as appropriate for the processing time and the processing load. In S1301, the calculator 122 calculates, in the same manner as in S107 in FIG. 4, the confidence of the movable object i cut out from the current frame using the detection rectangle for the movable object jₘ determined as the same object as the movable object i in the current frame.

In S1302, the detection rectangle determiner 124 compares the confidence calculated in each preceding frame with the confidence calculated with the bounding rectangle calculated in S103. The detection rectangle determiner 124 determines, of the rectangles with the confidences being compared, the rectangle with the greatest confidence as the detection rectangle for the movable object i. The confidence comparison in S1302 may be performed after the confidence calculation in S1301.

In the sixth embodiment, the information processing apparatus 1 compares the confidence calculated with the detection rectangle in each of multiple preceding frames with the confidence calculated with the bounding rectangle in the current frame. The information processing apparatus 1 examines multiple preceding frames in addition to the immediately-preceding frame to increase the confidence calculated with the output detected rectangle and output stable detection rectangles.

### Seventh Embodiment

In a seventh embodiment, the position and the size of the detection rectangle in the previous frame are corrected, and the corrected detection rectangle is used to calculate the confidence of the movable object detected in the current frame. Using the detection rectangle in the previous frame for the current frame may not yield an intended confidence due to the movement of the movable object in the current frame from the previous frame. The information processing apparatus 1 thus corrects the position or the size of the detection rectangle in the previous frame to improve the confidence based on the detection rectangle in the previous frame.

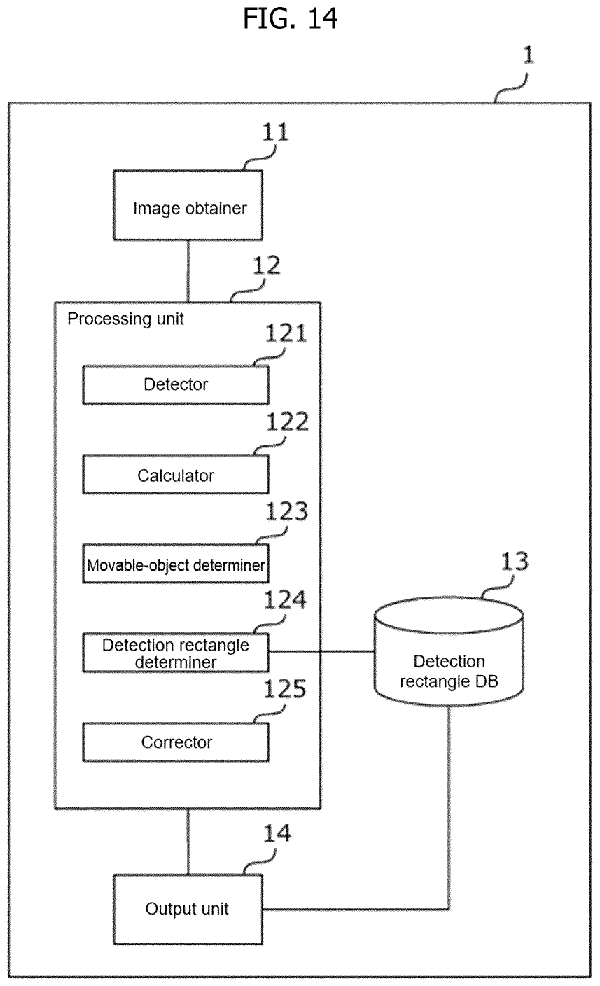

The hardware configuration of the information processing apparatus 1 according to the seventh embodiment is the same as in the first embodiment, and will not be described. FIG. 14 is a functional block diagram of the information processing apparatus according to the seventh embodiment. The information processing apparatus 1 in the seventh embodiment includes a corrector 125, in addition to the functional components in the first embodiment shown in FIG. 3. The same reference numerals denote the same functional components as in FIG. 3, and such components will not be described.

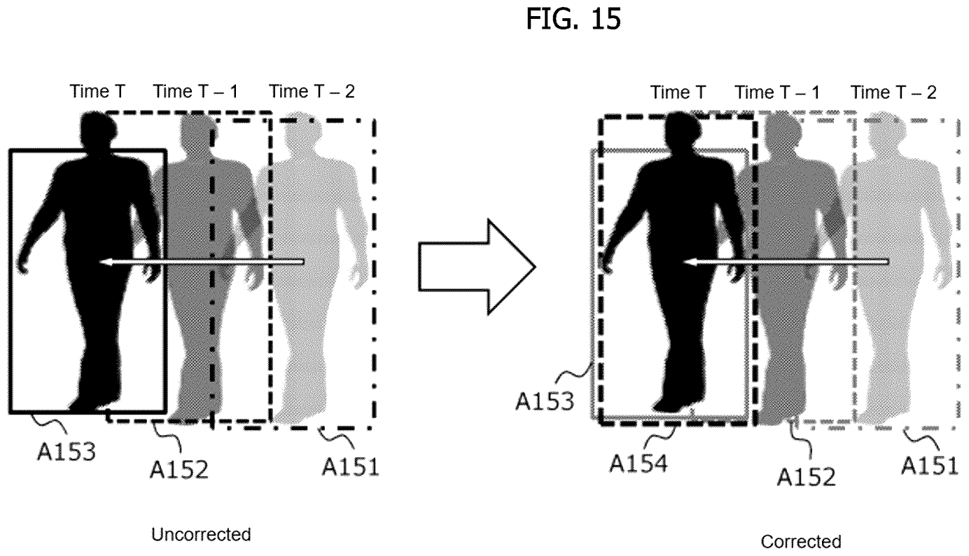

The corrector 125 corrects the detection rectangle in the previous frame for the same object as the movable object detected in the current frame. The correction of the detection rectangle will now be described with reference to FIG. 15. The current frame is imaged at time T, the previous frame is imaged at time T−1, and the frame before the previous frame is imaged at time T−2. A rectangle A151 is the detection rectangle for the movable object detected in the frame before the previous frame. A rectangle A152 is the detection rectangle for the movable object detected in the previous frame. Information about the rectangles A151 and A152 is stored in the detection rectangle database 13. A rectangle A153 is the bounding rectangle for the movable object detected in the current frame. In the example of FIG. 15, the head of the human is not recognized as the movable object, and the rectangle A153 surrounds the area excluding the head.

When the rectangle A152 in the previous frame is used for the current frame without being corrected, the rectangle A152 has a difference in the position of the movable object from the current frame due to the movement of the movable object. Thus, the confidence calculated with the rectangle A152 may be less than the confidence calculated with the rectangle A153 in which the head is not recognized as a movable object.

The corrector 125 corrects the position and the size of the rectangle A152 in the previous frame to be aligned with the position of the movable object in the current frame. The corrector 125 may calculate an estimated width, height, and center coordinates of the rectangle in the current frame based on, for example, the changes in the width, height, and center coordinates of the rectangle A152 in the previous frame and the rectangle A151 in the frame before the previous frame.

More specifically, the corrector 125 may estimate the direction and the distance of movement of the movable object based on the center coordinates of the detection rectangles in the previous frame and in the frame before the previous frame and calculate the center coordinates in the current frame. The corrector 125 may calculate the average of the widths and heights of the detection rectangles in the previous frame and in the frame before the previous frame as the width and height in the current frame. The corrector 125 generates a corrected rectangle A154 based on the calculated estimates.

With the confidence of the movable object in the current frame calculated based on the corrected rectangle A154, the information processing apparatus 1 outputs the detection rectangle with a greater confidence. The corrected rectangle may be generated based on the information about the bounding rectangle in the current frame and the detection rectangles in multiple preceding frames, other than based on the information about the detection rectangles in the previous frame and in the frame before the previous frame.

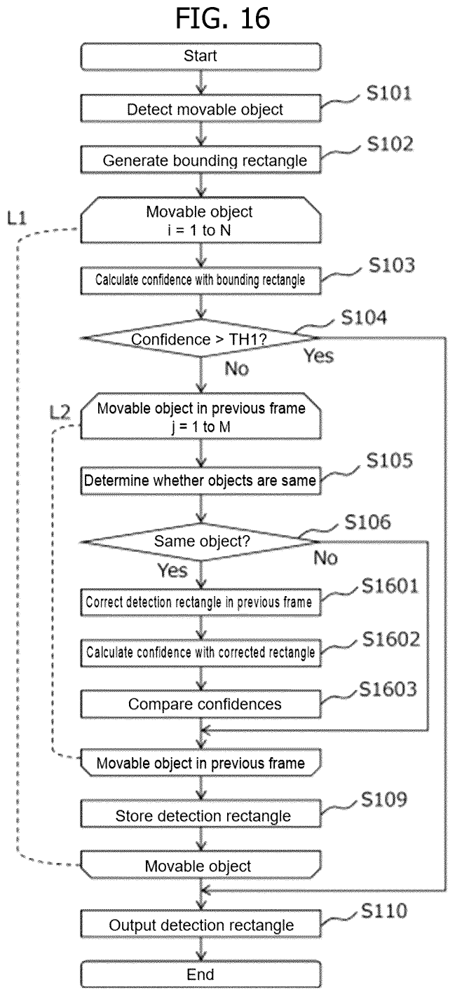

FIG. 16 is a flowchart of an example detection rectangle output process in the seventh embodiment. The detection rectangle output process in the seventh embodiment includes, in place of the processing in S107 and S108 in the detection rectangle output process in the first embodiment shown in FIG. 4, correcting the detection rectangle in the previous frame and calculating the confidence with the corrected rectangle (S1601 to S1603). The same reference numerals denote the same processing as in the detection rectangle output process in the first embodiment shown in FIG. 4, and such processing will not be described.

In the example of FIG. 16, for the movable object jₘ determined as, in S106, the same object as the movable object i in the current frame, the processing advances to S1601. In S1601, the corrector 125 corrects the detection rectangle for the movable object jₘ based on the change in position and size between the detection rectangle for the movable object jₘ and the detection rectangle for the movable object determined as the same object as the movable object i in the frame before the previous frame.

In S1602, the calculator 122 calculates the confidence of the movable object i cut out from the current frame with the corrected rectangle corrected in S1601. In S1603, the detection rectangle determiner 124 compares the confidence calculated in S1602 with the confidence calculated with the bounding rectangle in S103. When the confidence calculated with the bounding rectangle for the movable object i in the current frame is greater than the confidence calculated with the corrected rectangle, the detection rectangle determiner 124 determines the bounding rectangle as the detection rectangle for movable object i in the current frame. When the confidence calculated with the corrected rectangle is greater than the confidence calculated with the bounding rectangle, the detection rectangle determiner 124 determines the corrected rectangle as the detection rectangle for the movable object i in the current frame.

In the seventh embodiment, the corrector 125 corrects the detection rectangle for the movable object detected in the previous frame based on the detection rectangle in the frame before the previous frame. The information processing apparatus 1 corrects the detection rectangle in the previous frame and uses the corrected rectangle for the current frame, thus improving the confidence of the movable object.

### Others

The above embodiments describe exemplary structures according to one or more aspects of the present invention. The components in the above embodiments are not limited to the specific examples described above, but may be combined with one another as appropriate within the scope of the technical ideas of the present invention. The present invention may also be modified variously without departing from the scope of the technical ideas of the invention.

In each embodiment described above, the confidence as the likelihood of an object being a human is the confidence as the likelihood of an object being no specific person, but the confidence is not limited to this. The confidence may be the likelihood of an object being a specific person as a detection target.

In each embodiment described above, the previous frame or the multiple preceding frames are consecutive, but the frames are not limited to this. The information processing apparatus 1 may examine every two or three or more preceding frames and output a rectangle with a greater confidence as the detection rectangle in the current frame.

In each embodiment described above, the detection rectangle for the movable object detected in a frame preceding the current frame is used to calculate the confidence of the movable object in the current frame, but the frame used for the calculation is not limited to this. The information processing apparatus 1 may use, for an already captured video, a bounding rectangle for a movable object in a frame later than the current frame to calculate the confidence of the movable object in the current frame. In this case, when the confidence calculated with the bounding rectangle for the movable object detected in a later frame is greater than the confidence calculated with the bounding rectangle for the movable object in the current frame, the information processing apparatus 1 determines the bounding rectangle in the later frame as the detection rectangle in the current frame.

### APPENDIX 1

(1) An information processing apparatus (1), comprising:
   a detector (121) configured to detect a movable object in a frame image of a video;
   a calculator (122) configured to calculate a confidence of the detected movable object being a predetermined object; and
   a detection range determiner (124) configured to determine a detection range for a first movable object detected in a first frame based on a confidence of the first movable object calculated with a range circumscribing the first movable object and on a confidence of the first movable object in the first frame calculated with a detection range for a second movable object detected in a second frame preceding the first frame, and to record the determined detection range into a recorder.
(2) An information processing method implementable with a computer, the method comprising:
   (S101) detecting a first movable object in a first frame included in a video;
   (S103, S107) calculating a confidence of the first movable object being a predetermined object by using a range circumscribing the first movable object and using a detection range for a second movable object detected in a second frame preceding the first frame, the detection range being recorded in a recorder; and
   (S108, S109) determining, based on a confidence of the first movable object calculated with the range circumscribing the first movable object and on a confidence of the first movable object in the first frame calculated with the detection range for the second movable object, a detection range for the first movable object and recording the determined detection range into the recorder.

### DESCRIPTION OF SYMBOLS

1: information processing apparatus, 2: camera, 11: image obtainer, 12: processing unit, 121: detector, 122: calculator, 123: determiner, 124: determiner, 125: corrector, 13: detection rectangle database, 14: output unit

1. An information processing apparatus, comprising:
a detector configured to detect a movable object in a frame image of a video;
a calculator configured to calculate a confidence of the detected movable object being a predetermined object; and
a detection range determiner configured to determine a detection range for a first movable object detected in a first frame based on a confidence of the first movable object calculated with a range circumscribing the first movable object and on a confidence of the first movable object in the first frame calculated with a detection range for a second movable object detected in a second frame preceding the first frame, and to record the determined detection range into a recorder.

2. The information processing apparatus according to claim 1, further comprising:
a movable-object determiner configured to determine, selectively from a plurality of movable objects detected in the second frame, the second movable object being a same object as the first movable object.

3. The information processing apparatus according to claim 2, wherein
the movable-object determiner determines the second movable object being the same object as the first movable object based on a distance between a center of the range circumscribing the first movable object and a center of a detection range for each of the plurality of movable objects detected in the second frame.

4. The information processing apparatus according to claim 2, wherein
the movable-object determiner determines the second movable object being the same object as the first movable object based on a ratio of an overlapping area between the range circumscribing the first movable object and the detection range for each of the plurality of movable objects detected in the second frame to an area covered by the range circumscribing the first movable object and the detection range.

5. The information processing apparatus according to claim 2, wherein
the movable-object determiner determines the second movable object being the same object as the first movable object through matching between the first movable object and each of the plurality of movable objects detected in the second frame using a machine learning-based matching algorithm.

6. The information processing apparatus according to claim 2, wherein
the movable-object determiner determines, selectively from movable objects detected in each of a plurality of frames preceding the first frame, a movable object being the same object as the first movable object in each of the plurality of frames, and
in response to, of confidences of the first movable object calculated with detection ranges for movable objects determined to be the same object as the first movable object in the plurality of frames, a greatest confidence being greater than the confidence of the first movable object calculated with the range circumscribing the first movable object, the detection range determiner determines a detection range with the greatest confidence as the detection range for the first movable object.

7. The information processing apparatus according to claim 1, wherein
in response to the confidence of the first movable object calculated with the range circumscribing the first movable object being greater than a first threshold, the detection range determiner determines the range circumscribing the first movable object as the detection range for the first movable object.

8. The information processing apparatus according to claim 1, wherein
in response to the confidence of the first movable object calculated with the detection range for the second movable object being greater than the confidence of the first movable object calculated with the range circumscribing the first movable object, the detection range determiner determines the detection range for the second movable object as the detection range for the first movable object.

9. The information processing apparatus according to claim 1, wherein
in response to the confidence calculated with the determined detection range for the first movable object being greater than a second threshold, the detection range determiner records the detection range for the first movable object into the recorder.

10. The information processing apparatus according to claim 1, wherein
in response to the confidence of the first movable object calculated with the detection range for the second movable object being greater than the confidence of the first movable object calculated with the range circumscribing the first movable object and a number of consecutive frames each having a difference greater than a third threshold between the range circumscribing the first movable object and the detection range for the second movable object being less than or equal to a predetermined number, the detection range determiner determines the detection range for the second movable object as the detection range for the first movable object and records the determined detection range for the first movable object into the recorder.

11. The information processing apparatus according to claim 1, further comprising:
an output unit configured to superimpose the detection range for the first movable object recorded in the recorder on the first frame and output the detection range superimposed on the first frame.

12. The information processing apparatus according to claim 11, wherein
in response to a confidence calculated with the detection range for the first movable object recorded in the recorder being greater than a second threshold, the output unit outputs the detection range for the first movable object.

13. The information processing apparatus according to claim 11, wherein
in response to the confidence of the first movable object calculated with the detection range for the second movable object being greater than the confidence of the first movable object calculated with the range circumscribing the first movable object and a number of consecutive frames each having a difference greater than a third threshold between the range circumscribing the first movable object and the detection range for the second movable object being less than or equal to a predetermined number, the output unit outputs the detection range for the first movable object recorded in the recorder.

14. The information processing apparatus according to claim 11, wherein
in response to a number of consecutive frames each having a confidence calculated with the determined detection range for the first movable object being greater than a first threshold being greater than a predetermined number, the output unit outputs the detection range for the first movable object.

15. The information processing apparatus according to claim 1, further comprising:
a corrector configured to correct the detection range for the second movable object based on a change in position and size from the detection range for the second movable object to a detection range for a movable object determined to be a same object as the first movable object in a frame preceding the second frame.

16. The information processing apparatus according to claim 1, wherein
the detector detects the movable object by at least one of interframe subtraction or background subtraction.

17. The information processing apparatus according to claim 1, wherein
the calculator calculates the confidence of the detected movable object being the predetermined object by using a discriminator based on at least one of a neural network, boosting, or a support vector machine.

18. An information processing method implementable with a computer, the method comprising:
detecting a first movable object in a first frame included in a video;
calculating a confidence of the first movable object being a predetermined object by using a range circumscribing the first movable object and using a detection range for a second movable object detected in a second frame preceding the first frame, the detection range being recorded in a recorder; and
determining, based on a confidence of the first movable object calculated with the range circumscribing the first movable object and on a confidence of the first movable object in the first frame calculated with the detection range for the second movable object, a detection range for the first movable object and recording the determined detection range into the recorder.

19. A non-transitory computer readable medium storing a program for causing a computer to perform operations included in the information processing method according to claim 18.
